(19) United States
(12) Patent Application Publication
(10) Pub. No.: US 2008/0022829 A1
(43) Pub. Date: Jan. 31, 2008

(54) Edge punch

(75) Inventors: Sean Brosmith, Beverly Hills, CA (US); Harald Belker, Marina Del Rey, CA (US)

Correspondence Address: GREER, BURNS & CRAIN, 300 S WACKER DR, 25TH FLOOR, CHICAGO, IL, 60606, US

(73) Assignee: Helix USA

(21) Appl. No.: 11/496,207

(22) Filed: Jul. 31, 2006

(51) Int. Cl. B26D 7/01

(52) U.S. Cl. 83/620; 83/687

(57) ABSTRACT

An edge punch for creating a repeatable pattern on an edge of a target sheet, including a base including a floor panel, a sidewall projecting from the floor panel and a lever actuator disposed on the sidewall, and a cassette having an edge punch assembly constructed and arranged for being slidably received in the floor panel for lateral sliding movement to a designated operating position.

### BACKGROUND OF THE INVENTION

The present invention generally relates to a punching device, and more particularly relates to an edge punch for creating a repeatable pattern on an edge of a target sheet.

Punching devices are known in the art and generally include a punching die assembly having a designated pattern configured for creating the pattern on a target sheet, such as a sheet of paper or fabric. The assembly generally includes a punching die with a pattern knife having the designated pattern, a guide plate configured for accommodating the pattern knife, and a die bed spaced apart from the guide plate. The target sheet generally fits between the spaced apart guide plate and the die bed. Both the guide plate and the die bed generally include at least one aperture corresponding with the designated pattern on the pattern knife. Upon compression of the assembly, the pattern knife travels through the guide plate and into the target sheet, creating the designated pattern.

One problem that can occur in current punching devices is that the punching die assembly can move during operation, causing an incomplete or damaged pattern. To overcome this problem, punching devices were developed that include a base portion having an opening for receiving the punching die assembly, such as U.S. Publication No. 2005/0051017 to Weng. In Weng, the punching die assembly is constructed and arranged for being inserted into a corresponding opening in a base. Upon insertion, the assembly is locked into place by a key specially designed for securing the punching device within the opening.

However, in Weng, if the user damages or misplaces the key, the assembly can be difficult to remove from the opening without being damaged. Further, if the user decides not to use the key, it is possible that the assembly can be dislodged from the opening during use if it has not been properly inserted into the opening. Also, inserting the assembly into the opening may be difficult for younger users, who may not have the strength required to push down on and secure the assembly into the base opening.

Another problem that can arise in current edge punching devices is the difficulty in creating a continuous, aligned pattern along the length or width of and edge or border of the target sheet. Although the device in Weng provides a measurement guide on the base for alignment, it can still be difficult for the user to properly align the pattern because of the uncertainty of where the target sheet should be placed so that the new pattern can be aligned with the pattern already punched into the sheet.

Yet another problem that can arise in current edge punch devices is the need to purchase a new edge punch device whenever the user wishes to change patterns, due to a lack of interchangeability of the punching die assembly in many current edge punch devices.

Accordingly, there is a need for an improved edge punch device that securely holds the punching die assembly in place but that can be easily removed without the need for additional tools. There is also a need for an improved edge punch device that can be more easily inserted into and removed from the base by users of varying ages and strengths. Further, there is a need for an improved edge punch device that allows the user to more easily create a uniform and aligned pattern along the target sheet. Finally, there is a need for an edge punch device that allows a user to change patterns without the need to purchase an entirely new device.

### BRIEF SUMMARY OF THE INVENTION

The present edge punch meets or exceeds each of the above identified needs. The present edge punch includes a punching die assembly that laterally slides into a base and is more securely held in place during operation than current edge punch assemblies. Also, the present edge punch can be more easily inserted into and removed from the base by users of varying strengths and ages and does not require the use of additional tools. Further, the present edge punch includes an alignment feature that allows the user to more easily create an aligned and continuous pattern on a target sheet. The present edge punch device is more cost efficient than current edge punch devices by providing interchangeable punching cassettes that permit the user to change patterns without the need to purchase an entirely new assembly.

Specifically, an edge punch for creating a repeatable pattern on an edge of a target sheet includes a base including a floor panel, a sidewall projecting from the floor panel and a lever actuator disposed on the sidewall, and a cassette having an edge punch assembly constructed and arranged for being slidably received in the floor panel for lateral sliding movement to a designated operating position.

### BRIEF DESCRIPTION OF THE DRAWINGS

FIG. 1 is a front elevational perspective view of an edge punch according to the present invention in an operating position;

FIG. 2 is a front elevational perspective view of the present edge punch in an assembly position;

FIG. 3 is a front elevational perspective view of a base of the present edge punch;

FIG. 4 is a top view of the base of the present edge punch;

FIG. 5 is a bottom view of the base of the present edge punch;

FIG. 6 is a front elevational perspective view of a cassette of the present edge punch;

FIG. 7 is a front cross-sectional view of the cassette of FIG. 6 taken along the line 7-7 in FIG. 8;

FIG. 8 is a top view of the cassette of FIG. 6; and

FIG. 9 is a bottom view of the cassette of FIG. 6.

### DETAILED DESCRIPTION OF THE INVENTION

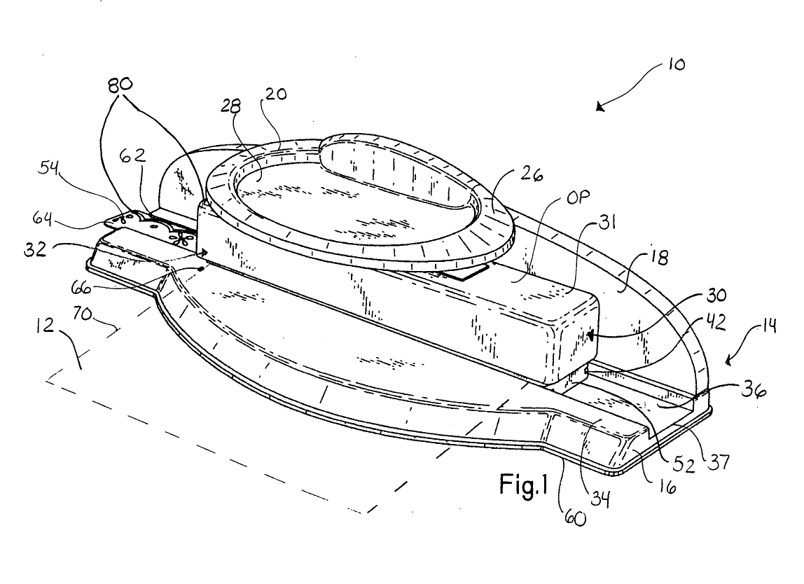

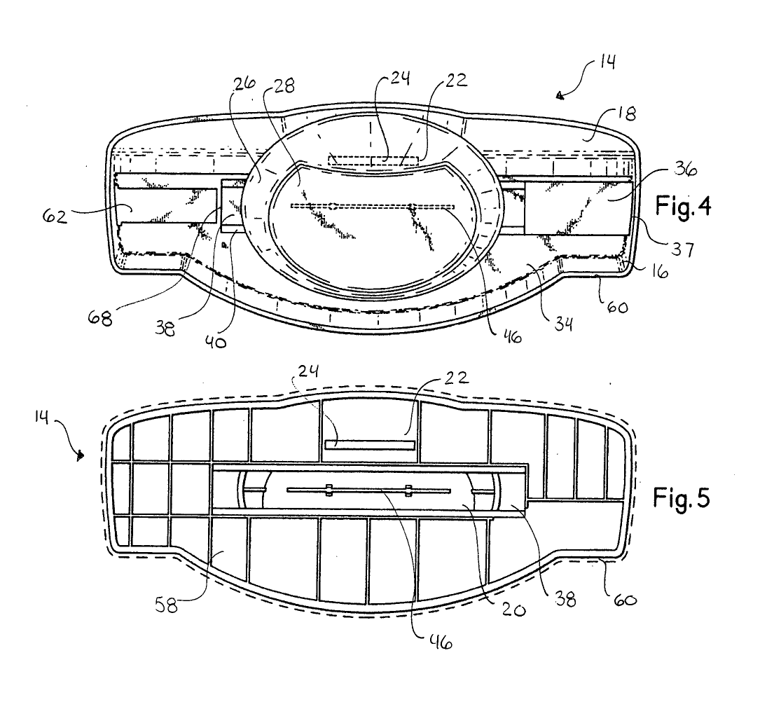

Referring now to FIGS. 1-4, an edge punch is generally designated 10 and is configured for creating a repeatable pattern on an edge of a target sheet 12. The edge punch 10 includes a base 14 including a floor panel 16, a sidewall 18 projecting generally vertically from the floor panel and a lever actuator 20 disposed on the sidewall. The base 14 is preferably manufactured and integrally formed from a lightweight, durable plastic, but it is contemplated that other materials with similar properties may be suitable, as known in the art. Preferably, the sidewall 18 is arranged generally perpendicular to the floor panel 16, but it is appreciated that other arrangements may be suitable, depending on the application.

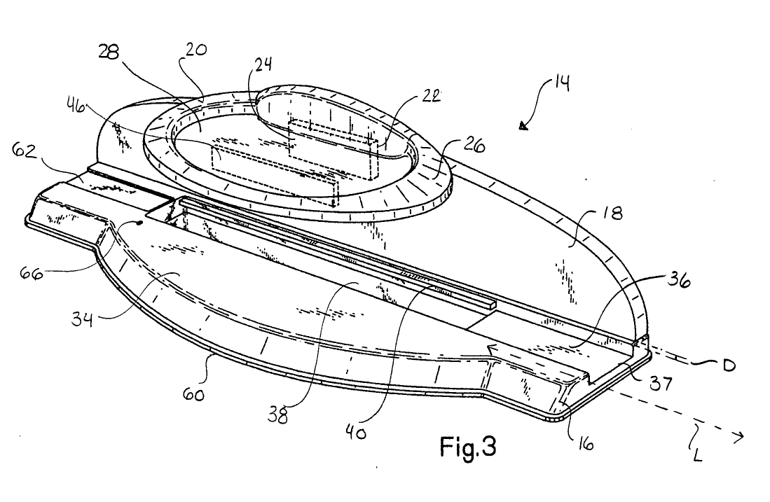

The lever 20 is preferably pivotally associated with the sidewall 18. Specifically, the sidewall 18 preferably defines an opening 22 configured for receiving a lever projection 24 extending generally perpendicular to the lever 20 (FIG. 3). The projection 24 is then pivotally connected within the opening by at least one pin (not shown), although it is recognized that other pivotable arrangements may be appropriate. The lever 20 is also preferably sized to accommodate a user's hand, and includes a top side 26 having a depression 28 configured for comfortably receiving the user's palm. However, it is appreciated that other configurations may be suitable, as known in the art.

A cassette 30 having an edge punch assembly 32 is constructed and arranged for being slidably received in the floor panel 16 for lateral sliding movement to a designated operating position “OP” (FIG. 1). The cassette 30 includes an outer housing 31 which is preferably manufactured from a lightweight and durable plastic, but it is recognized that other similar materials may be suitable.

Referring to FIG. 3, the floor panel 16 has an upper surface 34 defining a track 36 arranged along a longitudinal axis “L” of the floor panel for slidably receiving the cassette 30. It is contemplated that the track 36 is spaced apart from the sidewall 18 by a distance “D” in order to fully accommodate the cassette 30 and to prevent the cassette from rubbing against the sidewall, which could cause damage to the cassette and/or the sidewall. It is further contemplated that providing the cassette 30 with lateral sliding movement relative to the longitudinal axis of the floor panel upper surface 34 enables the user to more easily maneuver and utilize the cassette than current punches, where the cassette is generally forcibly inserted or pushed into a corresponding opening.

The upper floor panel surface 34 further includes a window 38 aligned with the track 36 and the operating position. As known in the art, the window 38 is preferably sized to accommodate the cassette 30. Preferably, the window 38 includes at least one ledge 40 constructed and arranged for slidably receiving the cassette 30.

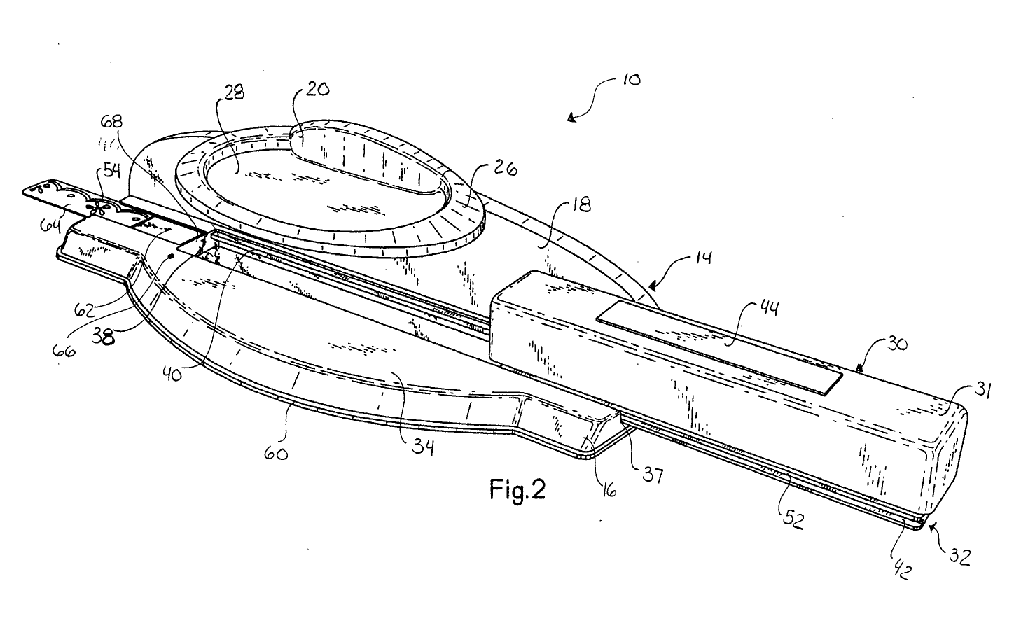

Referring to FIGS. 1 and 2, the at least one ledge 40 preferably extends substantially parallel to the upper surface 34. In order to be slidably received in the at least one ledge 40, the assembly 32 includes at least one groove 42 that is sized to accommodate the corresponding at least one ledge. Specifically, when the cassette 30 is placed into the track 36 via an open end 37, the user can laterally slide the cassette along the track and also along the longitudinal axis of the floor panel upper surface 34. Upon reaching the window 38, the at least one groove 42 in the assembly 32 will engage the associated at least one ledge 40, and the cassette 30 can laterally slide relative to the longitudinal axis of the floor panel upper surface 34 to the operating position. Preferably, the cassette 30 is configured for alignment with the window 38 at the operating position, as known in the art.

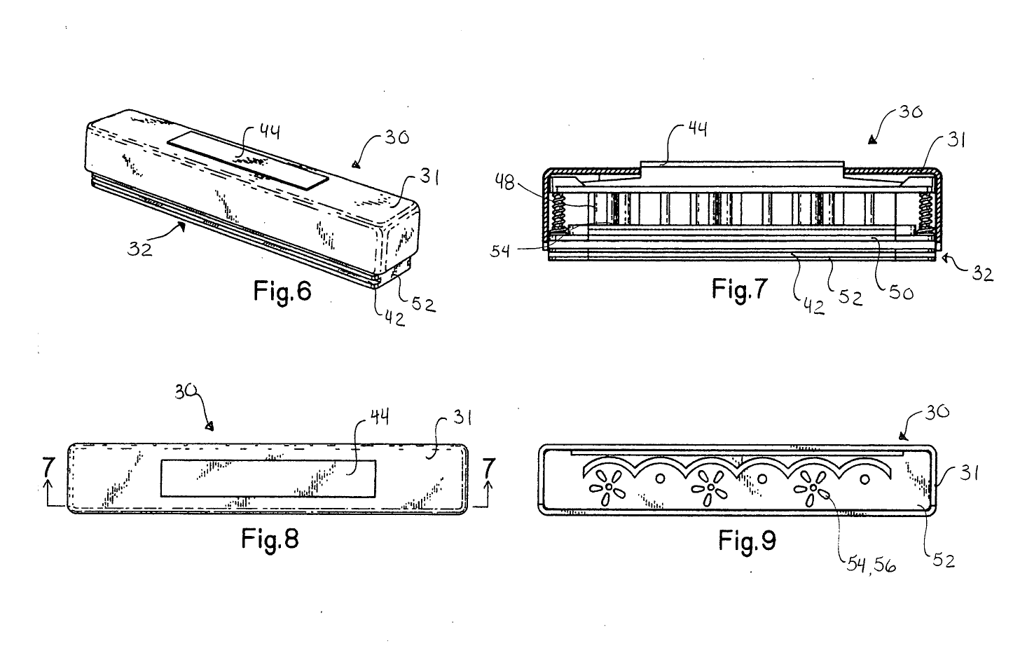

Referring to FIGS. 6-9, the edge punch assembly 32 includes a biasing compression member 44 constructed and arranged for engagement by a lever compression rib 46 (FIG. 3), a pattern knife 48, a guide plate 50 constructed and arranged for accommodating the pattern knife, and a die bed 52 spaced apart from and generally parallel to the guide plate. Each of the compression member 44, the pattern knife 48, the guide plate 50 and the die bed 52 are preferably arranged substantially parallel to each other, to ensure proper operation of the assembly 32. The at least one groove 42 is preferably located in the die bed 52, but it is appreciated that other locations may be suitable.

As seen in FIGS. 7 and 9, the edge punch assembly 32 is provided with a designated pattern 54 formed by the knife 48, and the guide plate 50 and the die bed 52 each includes at least one aperture 56 aligned with the pattern. As shown in FIGS. 1 and 2, when the user laterally slides the cassette 30 along the track 36 to the operating position, the compression member 44 is in alignment with the compression rib 46. Accordingly, when the user presses downward on the lever 20, a vertical force is applied to the compression rib 46, which engages the compression member 44, biasing the pattern knife 48 through the at least one aperture 56 in the guide plate 50 and the die bed 52, punching the designated pattern 54 into the target sheet 12. Such operation is well known in the punching art.

Referring to FIG. 5, the base 14 further includes a receptacle 58 in communication with the window 38 configured for collecting scraps generated during operation of the edge punch 10. The receptacle 58 is preferably an open-bottom of the base 14 having a removable end cover 60 (shown in dashed lines). The end cover 60 is preferably attached to the base 14 by a snap-fit, but it is appreciated that other methods of attachment may be suitable, such as a tongue-and-groove or hinged arrangement, depending on the application. When the receptacle 58 becomes full from repeated use of the punch 10, the user can remove the end cover 60 from the base 14, and empty the receptacle. However, it is appreciated that other ways of collecting and removing the scraps may be appropriate.

Referring to FIGS. 1-4, the base 14 further includes a channel 62 configured for slidably receiving an alignment tab 64 preferably imprinted with the designated pattern 54 and is manufactured from a lightweight, flexible plastic. Preferably, the channel 62 is aligned with the track 36 and the window 38. The base 14 further includes a guide stop 66 configured for aligning the target sheet 12 with the assembly 32 in the operating position. The guide stop 66 is preferably integrally formed with the base 14 and generally extends substantially perpendicular to the base. To enable proper placement of the target sheet 12 during operation, the guide stop 66 is also preferably aligned with the window 38 at a proximal edge 68 of the window, located proximal to the channel 62. It is contemplated that this arrangement will also prevent the target sheet from moving during operation.

During use of the edge punch 10, the user slidably inserts the alignment tab 64 into the channel 62, and slidably inserts the cassette 30 into the track 36 and laterally slides the cassette relative to the longitudinal axis of the floor panel upper surface 34 to the operating position. The user then inserts the target sheet 12 between the guide plate 50 and the die bed 52, aligning an edge 70 of the target sheet against the guide stop 66. As described above, upon compression of the lever 20, the compression member 44 is engaged, biasing the pattern knife 48 through the at least one aperture 56 in the guide plate 50, cutting through the target sheet 12 and then going through the at least one aperture in the die bed 52, ensuring that the designated pattern 54 has been completely punched into the target sheet. The scraps then fall through the window 38 and into the receptacle 58 for storage.

Referring to FIG. 1, to create a repeating and aligned pattern, the user slides the target sheet 12 so that the punched pattern in the target sheet is aligned with the designated pattern 54 on the alignment tab 64. The user then repeats the process of cutting/punching the designated pattern 54 into the target sheet 12 until the desired pattern is achieved. It is contemplated that the alignment tab 64 provides a more efficient and accurate manner for creating a continuous and aligned pattern on the target sheet than current edge punches, which typically utilize a measurement grid of some sort that can be difficult for the user, especially younger children, to understand.

It is also contemplated that the present invention includes a kit 80 for use with the edge punch 10 for creating a repeatable pattern on the edge 70 of the target sheet 12. It is preferred that the kit 80 includes at least one cassette 30 provided with the designated pattern 54 configured for lateral sliding relative to the longitudinal axis of the floor panel upper surface 34 within the track 36, and the corresponding alignment tab 64 provided with the designated pattern and configured for lateral sliding relative to the longitudinal axis of the floor panel upper surface 34 within the channel 62.

By utilizing the kit 80, it is contemplated that the user can use the single base 14 to accommodate several of the patterns 54, bypassing the need to purchase all of the base, cassette 30 and alignment tab 64 each time a different pattern is desired. Accordingly, several of the cassettes 30 can be interchanged into the base 14 as desired by the user, without the need to use a separate edge punch device 10 each time the user wishes to change patterns. Because only the single base 14 is needed, the user can create continuous and aligned patterns using several of the cassettes 30 and alignment tabs 54, without the need to set up an entirely new edge punch device each time the pattern is changed. By providing the kit 80, it is contemplated that the present edge punch 10 is more cost and space efficient than current edge punches that may not offer the possibility of interchangeable cassettes and alignment tabs with a single base.

While a particular embodiment of the present edge punch has been described herein, it will be appreciated by those of skill in the art that modifications can be made thereto without departing from the invention as set forth in the attached claims.

1. An edge punch for creating a repeatable pattern on an edge of a target sheet, comprising:
a base including a floor panel, a sidewall projecting from said floor panel and a lever actuator disposed on said sidewall; and
a cassette having an edge punch assembly constructed and arranged for being slidably received in said floor panel for lateral sliding movement to a designated operating position.

2. The edge punch of claim 1 wherein said sidewall is arranged generally perpendicular to said floor panel.

3. The edge punch of claim 1 wherein said floor panel has an upper surface defining a track arranged along a longitudinal axis of said floor panel for slidably receiving said cassette.

4. The edge punch of claim 3 wherein said upper surface further includes a window aligned with said track and said operating position and having at least one ledge constructed and arranged for slidably receiving said cassette.

5. The edge punch of claim 4 wherein said assembly includes at least one groove in said cassette constructed and arranged for being slidably received in said at least one ledge.

6. The edge punch of claim 5 wherein said assembly is configured for alignment with said window during said operating position.

7. The edge punch of claim 1 wherein said assembly includes a biasing compression member constructed and arranged for engagement by a lever compression rib, a pattern knife, a guide plate constructed and arranged for accommodating said pattern knife, and a die bed spaced apart from and generally parallel to said guide plate.

8. The edge punch of claim 7 wherein said assembly is provided with a designated pattern formed by said knife, and said guide plate and said die bed each include at least one aperture aligned with said pattern.

9. The edge punch of claim 4 wherein said base includes a receptacle in communication with said window configured for collecting scraps generated during operation of said edge punch.

10. The edge punch of claim 9 wherein said receptacle is an open-bottom of said base having a removable end cover.

11. The edge punch of claim 1 wherein said base further includes a channel configured for slidably receiving an alignment tab.

12. The edge punch of claim 11 wherein said channel is aligned with said track and said window.

13. The edge punch of claim 1 wherein said base further includes a guide stop configured for aligning the target sheet with said assembly in an operating position.

14. The edge punch of claim 1 wherein said lever is pivotally associated with said sidewall.

15. The edge punch of claim 14 wherein said lever includes a depending compression rib configured for engaging said cassette in said operating position.

16. A kit for use with an edge punch for creating a repeatable pattern on an edge of a target sheet, the edge punch having a floor panel including an upper surface defining a track extending along a longitudinal axis of the floor panel, a window located at a designated operating position and having at least one ledge extending therefrom, and a channel, the track, window and channel being aligned with each other, and a sidewall projecting from the floor panel and having a lever actuator including a depending compression rib, the kit comprising:
at least one cassette provided with a designated pattern configured for lateral sliding within said track and including a housing and a biasing punching die assembly; and
an alignment tab provided with each said designated pattern and configured for lateral sliding within the channel.

17. The kit of claim 16 wherein said assembly includes at least one groove configured for slidably engaging the at least one ledge.

18. The kit of claim 16 wherein said cassette is aligned with the window in the operating position.

19. The kit of claim 16 wherein said assembly includes a compression member constructed and arranged for engagement by the compression rib, a pattern knife provided with the designated pattern, a guide plate constructed and arranged for accommodating said pattern knife, and a die bed spaced apart from and generally parallel to said guide plate.

20. An edge punch for creating a repeatable pattern on an edge of a target sheet, comprising:
a base including a floor panel having an upper surface defining a track arranged along a longitudinal axis of said floor panel, a sidewall projecting from said floor panel, a lever actuator pivotally disposed on said sidewall, a channel configured for slidably receiving an alignment tab, and a window aligned with said track and said channel and being arranged at a designated operating position; and
a cassette having an edge punch assembly constructed and arranged for being slidably received in said track for lateral sliding movement to said operating position;
said base further including a guide stop configured for aligning the target sheet with said assembly in said operating position.
